(19) United States
(12) Patent Application Publication
(10) Pub. No.: US 2026/0147491 A1
(43) Pub. Date: May 28, 2026

(54) OPERATION METHOD OF STORAGE CONTROLLER AND REPLACING METHOD OF FIRMWARE IMAGE

(71) Applicant: Samsung Electronics Co., Ltd., Suwon-si (KR)

(72) Inventors: Sanghun Shin, Suwon-si (KR); Sewon Kim, Suwon-si (KR); Mingon Shin, Suwon-si (KR); Seongchan Jo, Suwon-si (KR)

(21) Appl. No.: 19/229,060

(22) Filed: Jun. 5, 2025

(30) Foreign Application Priority Data
Nov. 25, 2024 (KR) 10-2024-0169415

(51) Int. Cl. G06F 3/06

(52) U.S. Cl. CPC G06F 3/0622; G06F 3/0655; G06F 3/0679

(57) ABSTRACT

An example operating method of a storage controller controlling a memory device includes executing an existing firmware image stored in the memory device, obtaining a public key from the memory device, where the public key corresponds to signature data received from a host, generating a decrypted value by decrypting a new signature included in the signature data using the public key, generating a hash value by performing a hash operation on firmware content included in the existing firmware image, and replacing an existing signature included in the existing firmware image with the new signature when the decrypted value and the hash value match.

### CROSS-REFERENCE TO RELATED APPLICATION

This application claims the benefit under 35 USC 119(a) of Korean Patent Application No. 10-2024-0169415 filed on Nov. 25, 2024, in the Korean Intellectual Property Office, the entire disclosure of which is incorporated herein by reference.

### BACKGROUND

Firmware may refer to a program that controls a hardware device. Firmware may be injected into a storage space within a hardware device during the manufacturing of the hardware device. Attacks on a system including firmware and a hardware device may be attempted in various ways. Attackers may cause the system to perform an action intended by the attackers by providing modified firmware.

To provide security against an attack that modifies firmware, a hardware device may download firmware, verify whether the signature inserted into the firmware is inserted by a legitimate provider, and inject the downloaded firmware into the firmware storage space when the verification is complete.

### SUMMARY

The present disclosure relates to an operating method of a storage controller and a method for replacing a firmware image, in which a signature inserted in an existing firmware may be easily replaced with a new signature provided by a legitimate provider.

In general, according to some aspects, an operating method of a storage controller controlling a memory device includes executing an existing firmware image stored in the memory device; obtaining a public key from the memory device, wherein the public key is corresponding to signature data received from a host; generating a decrypted value by decrypting a new signature included in the signature data using the public key; generating a hash value by performing a hash operation on firmware content included in the existing firmware image; and replacing an existing signature included in the existing firmware image with the new signature when the decrypted value and the hash value match.

In general, according to some aspects, in a method of replacing a first signature of a firmware image stored in a storage device and including the first signature generated based on a first secret key, the method includes performing a hash operation on firmware content included in the firmware image and generating a hash value; generating a second signature of the firmware image by encrypting the hash value using a second secret key; providing signature data including the second signature and an index of the second secret key to the storage device together with a firmware download command; and providing a firmware commit command to the storage device.

In general, according to some aspects, in a method of replacing a first signature of a firmware image including the first signature generated based on a first secret key, the method includes performing a first hash operation on firmware content included in the firmware image and generating a first hash value, by a firmware build system; encrypting the first hash value using a second secret key and generating a second signature of the firmware image, by the firmware build system; providing signature data including the second signature and an index of the second signature to a storage device together with a firmware download command by the firmware build system; buffering the signature data by the storage device; providing a firmware commit command to the storage device by the firmware build system; selecting a second public key corresponding to the second secret key by referring to the index, by the storage device; generating a decrypted value by decrypting the second signature using the second public key by the storage device; generating a second hash value by performing a second hash operation on firmware content included in an existing firmware image stored in the storage device, by the storage device; and replacing the first signature included in the existing firmware image with the second signature by the storage device when the decrypted value and the second hash value match.

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a diagram illustrating an example of a storage system.

FIG. 2 is a diagram illustrating an example of a firmware build system.

FIG. 3 is a diagram illustrating an example of a firmware verification system.

FIG. 4 is a diagram illustrating an example of a firmware build system.

FIG. 5 is a diagram illustrating example operations of a firmware build system.

FIG. 6 is a diagram illustrating an example of a firmware download operation of a storage device.

FIG. 7 is a diagram illustrating an example of a firmware verification operation of a storage device.

FIG. 8 is a diagram illustrating an example of a firmware installation operation of a storage device.

FIG. 9 is a diagram illustrating an example of a firmware update operation of a storage controller.

### DETAILED DESCRIPTION

Hereinafter, example implementations will be described with reference to the accompanying drawings.

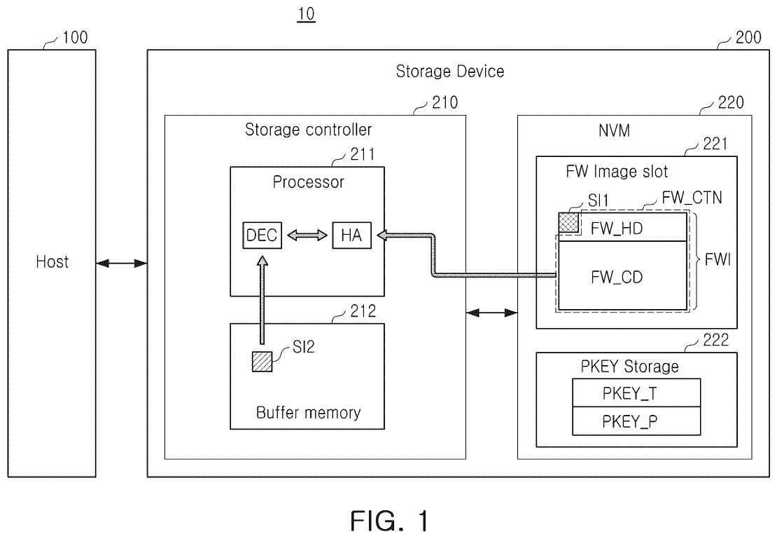

FIG. 1 is a drawing illustrating an example of a storage system.

Referring to FIG. 1, a storage system 10 may include a host 100 and a storage device 200. The storage device 200 may include a storage controller 210 and a nonvolatile memory device 220.

The host 100 may include at least one core that processes commands. For example, the host 100 may include an application processor, a microprocessor, a Central Processing Unit (CPU), a processor core, a multi-core processor, a multiprocessor, an Application-Specific Integrated Circuit (ASIC), and a Field Programmable Gate Array (FPGA).

The storage device 200 may include storage media for storing data in response to a request from the host 100. For example, the storage device 200 may include at least one of a solid state drive (SSD), an embedded memory, and a removable external memory. If the storage device 200 is an SSD, an embedded memory, or an external memory, the storage device 200 may further include a nonvolatile memory device.

In the case in which the storage device 200 is an SSD, the storage device 200 may be a device that follows the non-volatile memory express (NVMe) standard. If the storage device 200 is an embedded memory or an external memory, the storage device 200 may be a device that follows the universal flash storage (UFS) or embedded multi-media card (eMMC) standard. The host 100 and the storage device 200 may each generate a packet according to an adopted standard protocol and transmit the packet.

The storage device 200 may include a storage controller 210 and a nonvolatile memory device 220. The storage controller 210 may control the overall operation of the storage device 200. For example, the storage controller 210 may store data in the nonvolatile memory device 220 in response to a request from the host 100, and provide data stored in the nonvolatile memory device 220 to the host 100 in response to a request from the host 100.

When the nonvolatile memory device 220 includes a flash memory, the flash memory may include a 2D NAND memory array or a 3D (or vertical) NAND (VNAND) memory array. As another example, the storage device 200 may include various other types of nonvolatile memories. For example, the storage device 200 may be applied with various types of memory, such as a Magnetic RAM (MRAM), a Spin-Transfer Torgue MRAM, a Conductive bridging RAM (CBRAM), a Ferroelectric RAM (FeRAM), a Phase RAM (PRAM), a Resistive RAM, and others.

The storage controller 210 may include a processor 211 and a buffer memory 212. The processor 211 may execute firmware. The buffer memory 212 may temporarily store data provided from the host 100 or data output from the nonvolatile memory device 220.

The firmware may refer to software that controls the storage device 200. For example, the firmware of the storage device 200 may include a Flash Translation Layer (FTL). For example, the FTL may translate a logical address used in the host 100 into a physical address of the nonvolatile memory device 220, and perform management operations such as garbage collection and wear leveling.

To provide security against attacks that modify the firmware, a firmware provider may insert a signature into the firmware image and provide the signature to the storage device 200. For example, the provider of the firmware may be the manufacturer of the storage device 200.

The storage device 200 may download a firmware image with an inserted signature, verify the signature, and store the firmware image in the internal storage space only if the signature verification is successful.

The nonvolatile memory device 220 may include a firmware image slot 221 for storing a firmware image FWI and a public key storage unit 222. For example, the firmware image slot 221 may include a predetermined number of memory blocks among memory blocks for storing data of the nonvolatile memory device 220. The public key storage unit 222 may include at least a storage area of a read-only memory included in the nonvolatile memory device 220.

The firmware image FWI may include a header FW_HD and a code unit FW_CD. The code unit FW_CD may include a bootloader for booting the firmware and a source code for executing the firmware. In addition, the header FW_HD may store information related to the firmware. For example, the header may include the first signature data SI1.

The first signature data SI1 may be generated by encrypting a hash value obtained as a result of a hash operation on the remaining portion of the firmware image FWI excluding the first signature data SI1 portion using the first secret key.

Hereinafter, the portion of the firmware image FWI that is the target of the hash operation and the basis of the encryption may be referred to as firmware content FW_CTN. For example, the firmware content FW_CTN may be the remaining portion. However, the present disclosure is not limited thereto, and the firmware content FW_CTN may be a part of the remaining portion, for example, the code portion FW_CD. In addition, the first signature data SI1 may include multiple signatures for different portions of the firmware image. For example, the first signature data SI1 may include a signature for the code portion FW_CD and a signature for the entire remaining portion of the firmware image FWI excluding the first signature data SI1.

When the processor 211 receives the firmware image from the host 100, the processor may first store the firmware image in a buffer memory 212, for example, a download buffer. The processor 211 may verify the firmware image by extracting a signature included in the firmware image, decrypting the signature with a first public key PKEY_T corresponding to the first secret key, and comparing the decrypted value generated by performing a hash operation on the content with the hash value generated by performing a hash operation on the content. The first public key PKEY_T may be stored in advance in the public key storage unit 222.

If the two hash values match, the content included in the firmware image may be content provided by a legitimate provider. If the decrypted value and the hash value match, the processor 211 determines that the verification is successful, and may then store the firmware image FWI in the firmware image slot 221. On the other hand, if the decrypted value and the hash value are different, the content may have been tampered with or the signature may not be from a legitimate provider, and the processor 211 may remove the firmware image FWI buffered in the buffer memory 212.

There is a case where the signature of the firmware image of the storage device 200 is replaced. For example, to enhance the security of the firmware, it is required to limit the number of people who have access to the secret key for generating the signature included in the firmware image to be shipped.

For example, the secret key for generating the signature included in the firmware image to be shipped may be referred to as a product secret key. To limit the number of people who have access to the product secret key, developers who develop the firmware may develop the firmware using a development secret key that is different from the product secret key. Then, a limited number of people may create a signature for the firmware that has been developed using the product secret key, thereby generating the firmware image to be shipped.

Developers may perform a function test of the firmware with the signed firmware image installed in the storage device 200 using the development secret key. In addition, a limited number of people may encrypt the contents included in the firmware image using the product key, and the firmware image signed using the product secret key may be stored in the shipped storage device 200.

To replace the development firmware image signed using the development secret key with the product firmware image signed using the product secret key, replacing the entire firmware image stored in the storage device 200 may increase the time and cost for the function test of the firmware. For example, if the entire firmware image is replaced, it may be difficult to verify the identity between the contents of the development firmware image and the contents of the product firmware image. Therefore, even after the function test for the development firmware image is completed, if the product firmware image is installed in the storage device 200, the function test may have to be performed again with the product firmware image installed.

The period for the function test may take from 1 day at the shortest to 5 weeks or more depending on the test scope. Re-performing the function test simply to replace the signature of the firmware image may increase the time and cost for the function test, and may delay the release date of the storage device 200.

In some implementations, the host 100 may provide the storage device 200 with second signature data SI2 generated by encrypting the same content FW_CTN of the firmware image FWI to which the first signature data SI1 is added, using the second secret key. Then, the storage device 200 may store the second signature data SI2 in the buffer memory 212, and verify the consistency between the signature included in the second signature data SI2 and the content FW_CTN of the firmware image FWI. For example, the storage device 200 may verify whether the signature is a signature generated based on the same content as the content FW_CTN. If the verification is successful, the storage device 200 may replace the first signature data SI1 of the firmware image FWI with the second signature data SI2.

In some implementations, if the storage device 200 verifies that the content of the firmware image is identical to the content FW_CTN of the existing firmware image FWI, the first signature data SI1 may be replaced with the second signature data SI2 to obtain a signed firmware image using the product key. If the function test of the content of the firmware image is completed before replacing the first signature data SI1 with the second signature data SI2, the function of the firmware image may be guaranteed even without performing a separate function test after replacing the first signature data SI1 with the second signature data SI2. Therefore, the time and cost for the function test may be reduced.

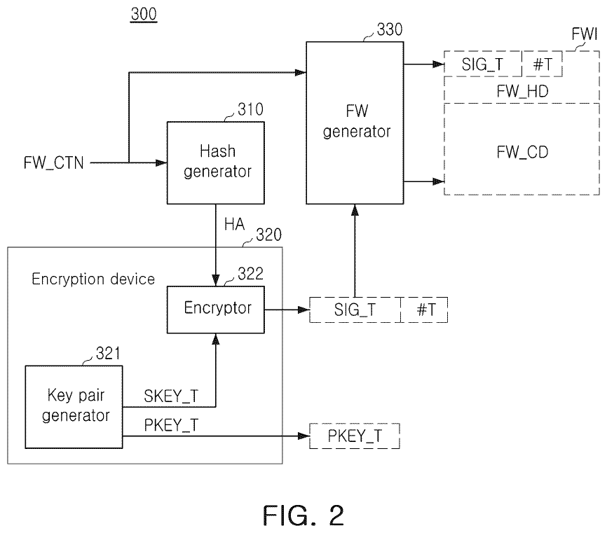

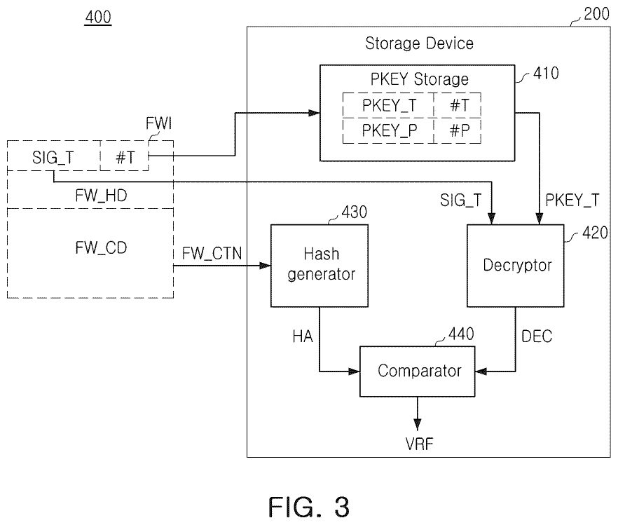

Before the example implementation is described in detail, a method of inserting a signature into a firmware image and a method of verifying a firmware with a signature inserted are described with reference to FIGS. 2 and 3.

FIG. 2 is a drawing illustrating an example of a firmware build system.

A firmware build system 300 may generate a signature by performing encryption based on firmware content FW_CTN and insert the signature into a firmware image. The operation of generating a firmware image with a signature inserted may be referred to as an operation of building the firmware.

Referring to FIG. 2, the firmware build system 300 may include a hash generator 310, an encryption device 320, and a firmware image generator 330.

The hash generator 310 may generate a hash value HA by performing a hash operation on the firmware content FW_CTN. For example, the hash operation may include an operation by a Secure Hash Algorithm (SHA). As described with reference to FIG. 1, the firmware content FW_CTN may include at least a portion of the remaining portion of the firmware image FWI excluding the signature data.

The encryption device 320 may generate a signature by encrypting a hash value HA. The encryption device 320 may include a key pair generator 321 and an encryptor 322.

The key pair generator 321 may generate a key pair composed of a secret key and a public key. For example, the key pair generator 321 may include a random number generator and may generate a key pair based on a random number.

The key pair generator 321 may generate and store a plurality of key pairs. For example, the key pair generator 321 may generate and store a development key pair and a product key pair.

In some implementations, the disclosure scope of the development key pair and the product key pair may be different. For example, the development key pair may be disclosed to developers of the firmware, and the product key pair may be disclosed to a small number of limited people without being disclosed to most developers. The development key pair may also be referred to as a temporary key pair.

In some implementations, the key pair generator 321 may store one or more development key pairs and multiple product key pairs. For example, when a provider of a storage device supplies storage devices to multiple customers, different product key pairs for storage devices supplied to different customers may be stored in the key pair generator 321.

An index may be assigned to each of the multiple key pairs. A signature generated by a certain secret key may be decrypted using a public key paired with the secret key. In order for the correspondence between the secret keys, the public keys, and the signatures to be identified, the secret keys and the public keys may be assigned an index.

FIG. 2 illustrates a secret key SKEY_T and a public key PKEY_T assigned an index # T among the multiple key pairs. The encryption device 320 may output the public key PKEY_T generated by the key pair generator 321 to the outside.

In some implementations, the encryption device 320 may not output the secret key SKEY_T used to generate the signature SIG_T. For example, the encryption device 320 may be a Hardware Security Module (HSM) server.

The encryptor 322 may generate a signature by encrypting a hash value HA received from the hash generator 310 using a secret key generated by the key pair generator 321. For example, the encryptor 322 may generate the signature SIG_T using the secret key SKEY_T.

In some implementations, the encryptor 322 may perform encryption using Elliptic Curve Digital Signature Algorithm (ECDSA). However, the present disclosure is not limited thereto, and the encryptor 322 may perform encryption using various encryption algorithms that utilize a key pair composed of a secret key and a public key. For example, the encryptor 322 may perform encryption using the Rivest-Shamir-Adleman (RSA) encryption algorithm.

The encryption device 320 may output the signature SIG_T generated by the encryptor 322 and the index # T of the secret key used to generate the signature to the outside. The encryption device 320 may further output the public key PKEY_T. A device having the output public key PKEY_T may decrypt the signature SIG_T using the public key PKEY_T.

The firmware image generator 330 may receive the signature SIG_T and the index # T from the encryption device 320 and generate a firmware header FW_HD including information about the code section FW_CD of the firmware and the signature SIG_T and the index # T. The signature SIG_T and the index # T may be collectively referred to as signature data. The firmware image generator 330 may output a firmware image FWI including a header FW_HD and a code portion FW_CD.

Using the signature SIG_T of the firmware image FWI, it may be verified whether the firmware content FW_CTN is from a legitimate provider.

FIG. 3 is a diagram illustrating an example of a firmware verification system.

The firmware verification system 400 may be implemented in a storage device 200 as described with reference to FIG. 1. The firmware verification system 400 may include a public key storage unit 410, a decryptor 420, a hash generator 430, and a comparator 440.

The firmware verification system 400 may verify the firmware content FW_CTN using a signature SIG_T included in the firmware image FWI.

The public key storage unit 410 may store public keys PKEY_T and PKEY_P output from the firmware build system 300 as described with reference to FIG. 2 in advance. For example, the public key storage unit 410 may correspond to the public key storage unit 222 as described with reference to FIG. 1.

The public key storage unit 410 may store a plurality of public keys. For example, the public key storage unit 410 may store a development public key PKEY_T and a product public key PKEY_P. One of the plurality of public keys may be selected based on the index # T added to the signature SIG_T of the firmware image FWI.

However, the present disclosure is not limited to the case where the plurality of public keys stored in the public key storage unit 410 are the development public key and the product public key. For example, the public key storage unit 410 may store two or more product public keys and support signature replacement of the firmware image even after the storage device 200 is shipped.

The decryptor 420 may generate a decrypted value DEC by decrypting the signature SIG_T using the same encryption algorithm as the encryption algorithm used in the encryptor 322 described with reference to FIG. 2, for example, ECDSA. For example, the decryptor 420 may obtain a signature SIG_T from the firmware image FWI and obtain a public key PKEY_T corresponding to the index # T from the public key storage unit 410.

The hash generator 430 may perform a hash operation using the same hash algorithm as the hash generator 310 described with reference to FIG. 2, for example, SHA. The hash generator 430 may output a hash value HA by performing a hash operation on the firmware content FW_CTN included in the firmware image FWI.

The comparator 440 may compare the hash value HA output from the hash generator 430 with the decrypted value DEC output from the decryptor 420 and output a verification result VRF. If the signature SIG_T is a signature generated by the hash value HA of the firmware content FW_CTN, the decrypted value DEC will be the same as the hash value HA.

For example, if the decrypted value DEC and the hash value HA are the same, the comparator 440 may output a signal corresponding to verification success as the verification result VRF. If the firmware verification is successful, the storage device 200 may install the firmware image FWI. Conversely, if the decrypted value DEC and the hash value HA are different, the comparator 440 may output a signal corresponding to verification failure as the verification result VRF, and the storage device 200 may remove the firmware image FWI without installing the firmware image.

In some implementations, the firmware build system 300 may provide a new signature to the storage device 200 to replace an existing signature of a firmware image FWI installed in the storage device 200 with a new signature. The firmware build system 300 may replace the signature without providing the entire firmware image with the new signature inserted to the storage device 200.

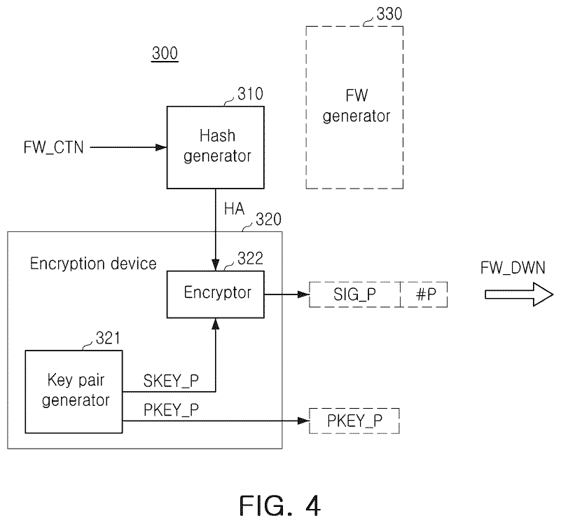

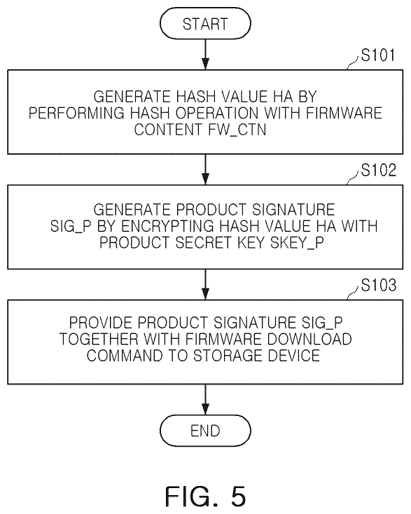

Hereinafter, the operation of the firmware build system 300 is described with reference to FIGS. 4 and 5.

FIG. 4 is a drawing illustrating an example of a firmware build system.

In some implementations, the firmware build system 300 may generate a signature SIG_P using firmware content FW_CTN and request the storage device 200 to replace the signature of an existing firmware image by providing the signature SIG_P and the index # P to the storage device 200.

The firmware build system 300 of FIG. 4 may have the same structure as the firmware build system 300 described with reference to FIG. 2. However, when providing the signature SIG_P and the index # P to replace the signature of an existing firmware image to the storage device 200, the firmware image generator 330 may be deactivated.

Referring to FIG. 4, the hash generator 310 may perform a hash operation on the firmware content FW_CTN and output a hash value HA. The firmware content FW_CTN may be identical to the firmware content FW_CTN included in the firmware image FWI as described with reference to FIG. 2.

The encryptor 322 may generate a signature SIG_P by performing an encryption operation on the hash value HA received from the hash generator 310 and the secret key SKEY_P received from the key pair generator 321. The secret key SKEY_P may be a secret key different from the secret key SKEY_T described with reference to FIG. 2. For example, the secret key SKEY_T of FIG. 2 may be a development secret key, and the secret key SKEY_P of FIG. 4 may be a product secret key.

The encryption device 320 may output a public key PKEY_P paired with the secret key SKEY_P in advance. The public key PKEY_P may be stored in advance in the storage device 200.

In addition, the encryption device 320 may output a signature SIG_P and an index # P.

In some implementations, the signature data including the signature SIG_P and the index # P can be provided to the storage device 200 together with the firmware download command FW_DWN. For example, the firmware download command FW_DWN may be a command defined in the Non-volatile memory express (NVMe) specification of the storage device 200.

FIG. 5 is a drawing explaining example operations of a firmware build system.

In operation S101, the firmware build system may perform a hash operation with the firmware content FW_CTN to generate a hash value HA.

In operation S102, the firmware build system may encrypt the hash value HA with the product secret key SKEY_P to generate a product signature SIG_P.

In operation S103, the firmware build system may provide the product signature SIG_P to the storage device together with the firmware download command. The firmware build system may further provide an index corresponding to the product signature SIG_P together with the product signature SIG_P.

In some implementations, the firmware build system 300 may omit an operation of building the firmware to provide the firmware image having the replaced signature to the storage device 200. In addition, the firmware build system 300 may provide the new signature and the index corresponding to the new signature to the storage device 200 instead of providing the entire firmware image to the storage device 200. Accordingly, the amount of computation and data transfer of the firmware build system 300 may be reduced.

In some implementations, the storage device 200 may verify the consistency of the new signature received from the firmware build system 300 and the firmware content FW_CTN, and replace the existing signature of the firmware image FWI with the new signature.

In some implementations, the storage device 200 may obtain a firmware image signed using a product secret key even if it does not receive the entire firmware image signed using the product secret key. In addition, if a function test on the content of the firmware image with an existing signature is completed, an additional function test on the content FW_CTN of the firmware image signed using the product secret key may be unnecessary.

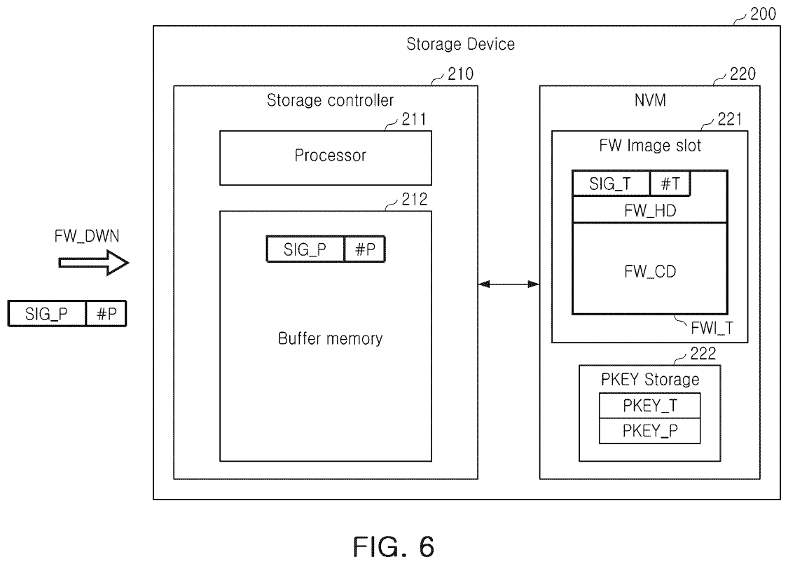

Hereinafter, a firmware update operation of a storage device will be described in detail with reference to FIGS. 6 to 9.

Referring to FIGS. 6 to 8, a storage device 200 is illustrated to explain the firmware update operation. The storage device 200 illustrated in FIGS. 6 to 8 may correspond to the storage device 200 described with reference to FIG. 1.

FIG. 6 is a drawing illustrating an example of a firmware download operation of a storage device.

An existing firmware image FWI_T may be stored in the firmware image slot 221. The existing firmware image FWI_T may be a firmware image built to include a first signature SIG # 1 corresponding to the first index # T. The public key storage unit 222 may store a first public key PKEY_T corresponding to the first index # T and a second public key PKEY_P corresponding to the second index # P.

In some implementations, the first key pair corresponding to the first index # T may be a development key pair or a temporary key pair, and the second key pair corresponding to the second index # P may be a product key pair.

When the processor 211 receives the second signature SIG_P and the second index # P together with the firmware download command FW_DWN, the processor 211 may store the second signature SIG_P and the second index # P in the buffer memory 212. The signature and index received with the firmware download command may also be referred to as signature data.

The storage device 200 may verify the data stored in the buffer memory 212 in response to the firmware download command FW_DWN, in response to the firmware commit command FW_CMT, and perform a firmware update after the verification is completed. Like the firmware download command FW_DWN, the firmware commit command FW_CMT may also be defined in the NVMe standard.

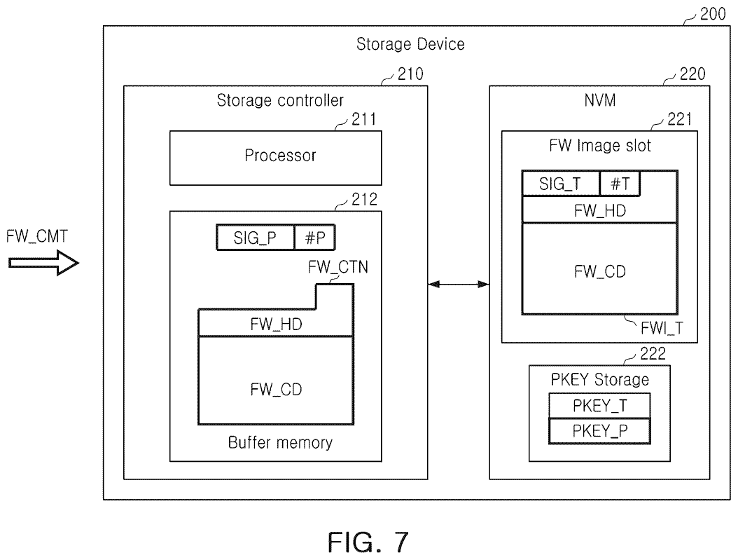

FIG. 7 is a diagram illustrating an example of a firmware verification operation of a storage device.

The processor 211 may verify the consistency of the second signature SIG_P and the firmware content FW_CTN of the existing firmware image FWI_T in response to the firmware commit command FW_CMT.

For example, the processor 211 may load the firmware content FW_CTN included in the existing firmware image FWI_T stored in the firmware image slot 221 into the buffer memory 212.

Then, the processor 211 may obtain the second public key PKEY_P from the public key storage unit 222 by referring to the second index # P added to the second signature SIG_P. The processor 211 may generate a decrypted value by decrypting the second signature SIG_P with the second public key PKEY_P.

The processor 211 may generate a hash value by performing a hash operation on the firmware content FW_CTN. Then, the processor 211 may verify the consistency between the second signature SIG_P and the firmware content FW_CTN by comparing the decrypted value and the hash value. If the decrypted value and hash value are the same, it may be verified that the second signature SIG_P is a signature generated by a legitimate provider of the firmware content FW_CTN.

If the consistency verification between the second signature SIG_P and the firmware content FW_CTN is successful, the storage device 200 may update the existing firmware image FWI_T with a firmware image having the second signature SIG_P.

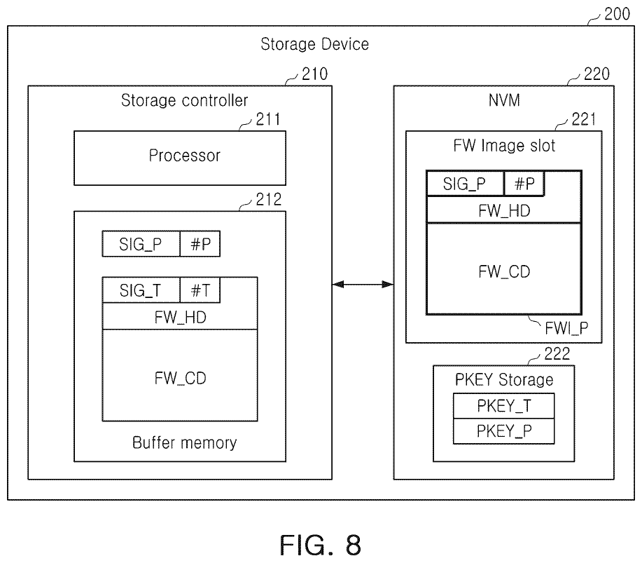

FIG. 8 is a drawing illustrating an example of a firmware installation operation of a storage device.

The processor 211 may control to replace the first signature SIG_T and the first index # T in the existing firmware image FWI_T with the second signature SIG_P and the second index # P, and to store the replaced firmware image FWI_P in the firmware image slot 221.

For example, the processor 211 may load the existing firmware image FWI_T into the buffer memory 212, and to overwrite the first signature SIG_T and the first index # T stored in the designated area with the second signature SIG_P and the second index # P, thereby generating the replaced firmware image FWI_P, and to store the replaced firmware image FWI_P in the firmware image slot 221.

In some implementations, the replaced firmware image FWI_P may include the same firmware content FW_CTN as the existing firmware image FWI_T. Therefore, if a function test for the firmware content FW_CTN of the existing firmware image FWI_T has been completed, the storage device 200 may not require an additional function test after updating the existing firmware image FWI_T to the replaced firmware image FWI_P. Therefore, in the case of replacing only the firmware signature, the cost and time required for the function test may be reduced.

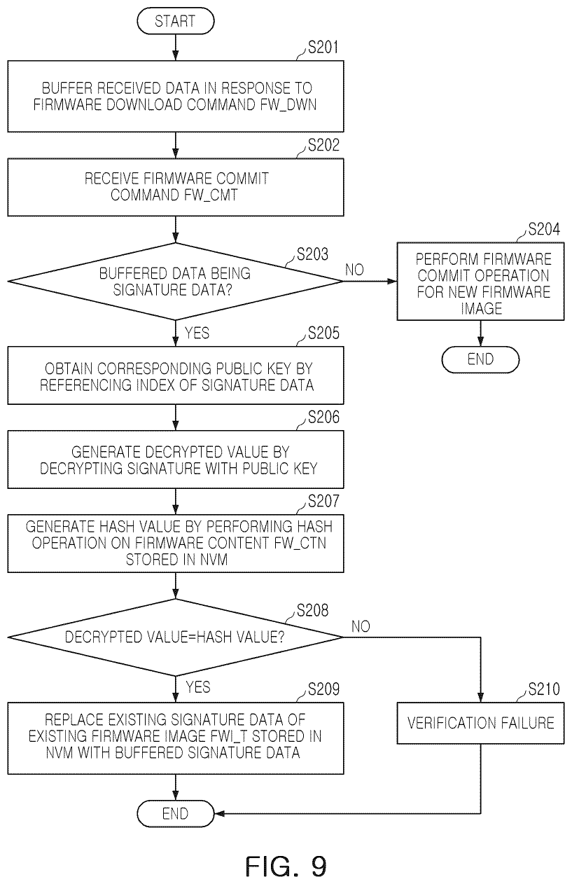

FIG. 9 is a diagram illustrating an example of a firmware update operation of a storage controller.

Operations S201 to S210 of FIG. 9 may be performed by the storage controller executing the existing firmware image stored in the nonvolatile memory device.

In operation S201, the storage controller may buffer data received together with the firmware download command FW_DWN in a buffer memory in response to a firmware download command FW_DWN from the host. The received data may include replacement signature data or may include a firmware image with a signature inserted.

In operation S202, the storage controller may receive a firmware commit command FW_CMT from the host.

In operation S203, the storage controller may determine whether the buffered data is signature data. For example, a signature generated based on a predetermined encryption algorithm may have a predetermined size or a predetermined range of sizes. In addition, an index corresponding to the signature may also have a predetermined size.

Accordingly, if the buffered data has a size within a predetermined range, the storage controller may determine the buffered data as signature data. Conversely, if the size of the buffered data is outside the predetermined range, the storage controller may determine the buffered data as data that is not signature data.

If the buffered data is not signature data (“No” in operation S203), the buffered data may be a new firmware image with a signature inserted. Therefore, in operation S204, the storage controller may perform a firmware commit operation for the new firmware image. For example, the storage controller may verify the consistency of a signature included in a new firmware image and the contents included in the new firmware image, and if the verification is successful, update the new firmware image.

If the buffered data is signature data (in operation S203, “Yes”), the storage controller may obtain a corresponding public key by referencing an index included in the signature data in operation S205. For example, the nonvolatile memory device may store a plurality of pre-injected public keys, and the plurality of public keys may be identified by an index. The storage controller may obtain a public key corresponding to an index included in the signature data among the plurality of public keys from the nonvolatile memory device.

In operation S206, the storage controller may generate a decrypted value by decrypting the signature included in the signature data using the obtained public key.

In operation S207, the storage controller may generate a hash value by performing a hash operation on the firmware content FW_CTN included in the existing firmware image stored in the nonvolatile memory device (NVM).

In operation S208, the storage controller may determine whether the decrypted value and the hash value are identical.

If the decrypted value and the hash value are the same, the storage controller may replace the existing signature data of the existing firmware image FWI_T stored in the nonvolatile memory device (NVM) with the signature data buffered in the buffer memory in operation S209.

For example, the storage controller may load the existing firmware image stored in the firmware image slot of the nonvolatile memory device (NVM) into the buffer memory. The location where the signature data is stored in the firmware image may be determined in advance. For example, in a firmware image composed of a plurality of data bits, the bit orders occupied by the signature data may be determined. The storage controller may update the firmware image by overwriting the buffered signature data in the determined location, and store the updated firmware image in the firmware image slot of the nonvolatile memory device (NVM).

If the decrypted value and the hash value are different, the storage controller may determine that the signature verification has failed in operation S210, and terminate the operation according to the firmware commit command.

In some implementations, the storage controller does not need to receive the entire firmware image including the new signature to replace the signature of the firmware image, and may receive new signature data including the new signature and the index of the new signature. In addition, since the storage controller may replace the signature of the firmware image by replacing the signature data of the existing firmware image with the new signature data, there is no need to re-perform a function test on the content included in the firmware image whose signature has been replaced.

Therefore, the time and cost required for the function test on the firmware image of the storage device may be reduced.

As set forth above, in a method for replacing a firmware image, a signature inserted into an existing firmware may be replaced with a new signature provided by a legitimate provider. In the case in which the functional test of the main part of the existing firmware is completed, additional functional tests for the firmware into which the new signature is inserted may be omitted. As a result, the time and cost for functional testing of the firmware may be reduced.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While example implementations have been illustrated and described above, it will be apparent to those skilled in the art that modifications and variations could be made without departing from the scope of the present disclosure as defined by the appended claims.

What is claimed is:

1. An operating method of a storage controller controlling a memory device, comprising:
executing an existing firmware image stored in the memory device;
obtaining a public key from the memory device, wherein the public key corresponds to signature data received from a host;
generating a decrypted value based on decrypting, using the public key, a new signature included in the signature data;
generating a hash value based on performing a hash operation on firmware content included in the existing firmware image; and
replacing an existing signature included in the existing firmware image with the new signature based on the decrypted value matching the hash value.

2. The operating method of claim 1, comprising:
receiving, from the host, download data and a firmware download command;
buffering the download data; and
determining, based on a size of the download data being within a predetermined range, that the download data is the signature data.

3. The operating method of claim 1, comprising:
receiving, from the host, download data and a firmware download command;
buffering the download data; and
determining, based on a size of the download data being outside a predetermined range, that the download data is a new firmware image.

4. The operating method of claim 1, wherein obtaining the public key from the memory device includes referencing a new index included in the signature data, and wherein the public key corresponds to the new index.

5. The operating method of claim 4, wherein replacing the existing signature included in the existing firmware image with the new signature includes:
loading the existing firmware image stored in the memory device;
overwriting, in the loaded existing firmware image, the existing signature and an existing index with the new signature and the new index, respectively, to obtain a new firmware image; and
storing the new firmware image in the memory device.

6. The operating method of claim 1, wherein generating the decrypted value is performed based on a firmware commit command from the host.

7. The operating method of claim 6, comprising terminating an operation according to the firmware commit command based on the decrypted value being different from the hash value.

8. The operating method of claim 6, comprising receiving, from the host, download data and a firmware download command,
wherein the firmware download command and the firmware commit command are defined in a non-volatile memory express (NVMe) specification.

9. The operating method of claim 1, wherein generating the decrypted value includes performing decryption using Elliptic Curve Digital Signature Algorithm (ECDSA).

10. The operating method of claim 1, wherein generating the hash value includes performing the hash operation using Secure Hash Algorithm (SHA).

11. A method of replacing a first signature of a firmware image stored in a storage device, the first signature being generated based on a first secret key, the method comprising:
performing a hash operation on firmware content included in the firmware image to generate a hash value;
generating a second signature of the firmware image based on encrypting the hash value using a second secret key;
providing signature data and a firmware download command to the storage device, the signature data including the second signature and an index of the second secret key; and
providing a firmware commit command to the storage device.

12. The method of claim 11, wherein performing the hash operation on the firmware content comprises using Secure Hash Algorithm (SHA).

13. The method of claim 11, wherein generating the second signature includes performing encryption using Elliptic Curve Digital Signature Algorithm (ECDSA).

14. The method of claim 11, wherein the firmware download command and the firmware commit command are defined in Non-volatile memory express (NVMe) specification.

15. The method of claim 11, comprising:
storing, before the firmware image is stored in the storage device, a first public key, a first index, a second public key, and a second index in the storage device, wherein the first public key and the first index correspond to the first secret key, and wherein the second public key and the second index correspond to the second secret key.

16. A method of replacing a first signature of a firmware image, the first signature being generated based on a first secret key, the method comprising:
performing, by a firmware build system, a first hash operation on firmware content included in the firmware image and generating, by the firmware build system, a first hash value based on the first hash operation;
encrypting, by the firmware build system, the first hash value based on a second secret key and generating, by the firmware build system, a second signature of the firmware image;
providing, by the firmware build system, signature data and a firmware download command to a storage device, the signature data including the second signature and an index of the second signature;
buffering, by the storage device, the signature data;
providing, by the firmware build system, a firmware commit command to the storage device;
selecting, by the storage device, a second public key corresponding to the second secret key based on the index of the second signature;
generating, by the storage device, a decrypted value based on decrypting the second signature using the second public key;
generating, by the storage device, a second hash value based on performing a second hash operation on firmware content included in an existing firmware image stored in the storage device; and
replacing, by the storage device, the first signature included in the existing firmware image with the second signature based on the decrypted value matching the second hash value.

17. The method of claim 16, wherein selecting the second public key includes obtaining the second public key from a read-only memory, wherein the read-only memory stores a plurality of public keys including a first public key and the second public key, and wherein the first public key corresponds to the first secret key.

18. The method of claim 16, wherein replacing the first signature included in the existing firmware image with the second signature includes:
loading the existing firmware image from a firmware image slot included in a nonvolatile memory device;
overwriting, in the loaded existing firmware image, the first signature and an index corresponding to the first signature with the second signature and the index of the second signature, respectively; and
storing, in the firmware image slot, the firmware image overwritten with the second signature and the index of the second signature.

19. The method of claim 16, wherein the first hash operation and the second hash operation are performed based on a same hash algorithm.

20. The method of claim 16, wherein the encryption and the decryption are performed based on a same encryption algorithm.
